(19) United States
(12) Patent Application Publication
(10) Pub. No.: US 2014/0293619 A1
(43) Pub. Date: Oct. 2, 2014

(54) HOUSING FOR AN ILLUMINATING APPARATUS AND AN ILLUMINATING APPARATUS HAVING THE HOUSING

(71) Applicants: Yaojun Feng, Shenzhen (CN); Yuanyuan He, Shenzhen (CN); Aiai Li, Shenzhen (CN); Haiping Yuan, Shenzhen (CN)

(72) Inventors: Yaojun Feng, Shenzhen (CN); Yuanyuan He, Shenzhen (CN); Aiai Li, Shenzhen (CN); Haiping Yuan, Shenzhen (CN)

(73) Assignee: OSRAM GMBH, Muenchen (DE)

(21) Appl. No.: 14/240,751

(22) PCT Filed: Aug. 31, 2012
(86) PCT No.: PCT/EP2012/066944

§ 371 Date: May 6, 2014

(30) Foreign Application Priority Data
Sep. 5, 2011 (CN) 201110261519.1

(51) Int. Cl. F21V 15/01; F21V 13/04; F21V 5/04

(52) U.S. Cl. CPC F21V 15/01; F21V 5/04; F21V 13/04
USPC 362/335; 362/363; 362/341

(57) ABSTRACT

A housing for an illuminating apparatus may include: two housing portions assembled together, and a transparent cover, the two housing portions and the transparent cover jointly defining a cavity, wherein a transparent separator is provided in the cavity for separating the cavity into an assembling cavity and an isolated cavity sealed with respect to each other, wherein the assembling cavity is configured to mount a plurality of lighting assemblies of the illuminating apparatus, and the isolated cavity is defined jointly by the transparent cover and the separator.

### RELATED APPLICATIONS

The present application is a national stage entry according to 35 U.S.C. §371 of PCT application No.: PCT/EP2012/066944 filed on Aug. 31, 2012, which claims priority from Chinese application No.: 201110261519.1 filed on Sep. 5, 2011, and is incorporated herein by reference in its entirety.

### TECHNICAL FIELD

Various embodiments relate to a housing used for an illuminating apparatus and capable of preventing condensation of water vapor therein. In addition, various embodiments further relate to an illuminating apparatus having the housing of the above type.

### BACKGROUND

An outdoor illuminating apparatus is usually provided with a waterproof and dustproof housing due to the characteristics of the environment where the illuminating apparatus is used. A lighting assembly such as LED lighting assembly of the illuminating apparatus is placed in a corresponding assembling cavity of the housing, while the temperature in the assembling cavity will be quite high since the lighting assembly, especially the LED lighting assembly, generates a lot of heat in operation. When the temperature outside is very low, the humid air in the assembling cavity will be condensed so as to be gathered together on a transparent cover of the housing, affecting output of light. What's more important is the condensed humid air might rust and corrode metal parts in the housing, and even short-circuits the LED lighting assembly.

### SUMMARY

Therefore, the present disclosure provides a housing for an illuminating apparatus. The housing can prevent the phenomenon of humidity condensation therein while it can be waterproof and dustproof. In addition, the present disclosure further provides an illuminating apparatus having the housing of the above type.

Various embodiments provide a housing for an illuminating apparatus through the following solution. The housing includes: two housing portions assembled together and a transparent cover, the two housing portions and the transparent cover jointly defining a cavity, wherein a transparent separator is provided in the cavity for separating the cavity into an assembling cavity and a isolated cavity sealed with respect to each other, and the assembling cavity is configured to mount a lighting assembly of the illuminating apparatus, and wherein the isolated cavity is defined jointly by the transparent cover and the separator. In various embodiments, heat generated by the elements in the assembling cavity will not be easily transferred to an area of the transparent cover by separating the assembling cavity from the isolated cavity, thus reducing a difference in temperature between both sides of the transparent cover, so as to reduce a risk of humidity condensation in the housing to a great extent, prevent rust or corrosion of metal parts in the housing, and even avoid short circuit of the lighting assembly.

Preferably, the isolated cavity is vacuum. The vacuum isolated cavity can well insulate heat, which further prevents the heat from the assembling cavity from being transferred to the transparent cover, and the risk of humidity condensation in the isolated cavity will be absolutely eliminated since there is no air in the isolated cavity.

According to various embodiments, a plurality of lenses are arranged at one side of the separator facing the assembling cavity and each of them is assigned corresponding to one lighting assembly of the illuminating apparatus. In various embodiments, the illuminating apparatus preferably is an LED illuminating apparatus. Each lighting assembly, i.e., each LED chip, of the LED illuminating apparatus is provided with an individual lens, which is favorable for the lens to processing independently the light from the LED chip, so as to realize an expected optical illuminating effec.

Preferably, the lenses and the separator are formed in one piece, which greatly reduces the number of parts in the housing, and relative locations between the lenses and the lighting assembly can be simply determined when the separator is mounted since the locations between the lenses and the separator are fixed, which prominently reduces the mounting difficulty.

According various embodiments, one side of the separator facing the assembling cavity is provided with a plurality of reflectors each corresponding to one lighting assembly of the illuminating apparatus. Such reflector also can adjust the light from the lighting assembly, especially the LED chip, so as to realize an expected optical illuminating effect.

According to various embodiments, one housing portion which is from the two housing portions and not mounted with the transparent cover is configured as a heat sink. To configure the heat sink as one housing portion is favorable to further reducing the number of parts of the housing. At the same time, since the heat sink itself is one portion of the housing, heat from the lighting assembly of the illuminating apparatus directly thermally connected with the heat sink can be directly discharged to the surrounding environment through the heat sink, which improves the thermal dissipating performance of the housing to a great extent.

According to various embodiments, the separator is formed in one piece with one housing portion that is from the housing portions and provided with the transparent cover, which reduces the number of parts of the housing, so that the housing is assembled completely when the two housing portions are assembled together, greatly reducing the assembling difficulty.

Preferably, the separator and the transparent cover are made from a glass or plastic, and of course, also can be made from other types of transparent materials.

Various embodiments further provide an illuminating apparatus through the following solution. The illuminating apparatus has the housing of the above type and is capable of effectively reducing the risk of humidity condensation therein.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a sectional view of a first embodiment of a housing according to the present disclosure;

FIG. 2 is an enlarged schematic diagram of region A of the housing of the first embodiment;

FIG. 3 is a sectional view of a second embodiment of a housing according to the present disclosure; and

FIG. 4 is an enlarged schematic diagram of region A of the housing of the second embodiment.

### DETAILED DESCRIPTION

The following detailed description refers to the accompanying drawing that show, by way of illustration, specific details and embodiments in which the disclosure may be practiced.

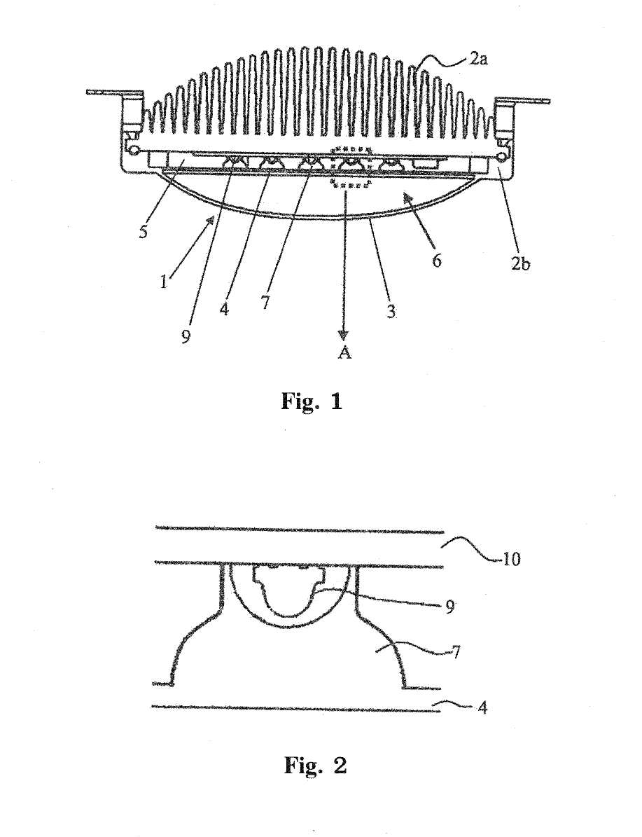

FIG. 1 is a sectional view of a first embodiment of a housing according to the present disclosure. As can be seen from the figure, the housing 1 has two housing portions 2a, 2b that are assembled together, wherein the housing portion 2b is provided with a transparent cover 3, the housing portion 2a is configured as a heat sink, and the two housing portions 2a, 2b and the transparent cover 3 jointly define a cavity. As further can be seen from the figure, in the cavity is provided a transparent separator 4 separating the cavity into an assembling cavity 5 and a isolated cavity 6 sealed with respect to each other, wherein in the assembling cavity 5 are provided a printed circuit board 10 and a plurality of lighting assemblies 9 and other elements mounted on the printed circuit board 10. In the present embodiment, the illuminating apparatus is configured as an LED illuminating apparatus, and then the assembling cavity 5 is provided with an LED chip, a driver, etc.

It further can be seen from FIG. 1 that the isolated cavity 6 is defined jointly by the separator 4 and the transparent cover 3. That is to say, viewing from a light path of light emitted from the lighting assembly 9, a isolated cavity 6 is formed in front of the assembling cavity 5, thus heat from the lighting assembly 9 in the assembling cavity 5 will be blocked by the isolated cavity 6 and will not be transferred onto the transparent cover 3. Therefore, a too big difference in temperature will not occur to the inside and outside of the transparent cover 3. In addition, even if there is a too big difference in temperature between the inside and outside of the transparent cover 3, a phenomenon of humidity condensation will not take place on the transparent cover 3 since the isolated cavity 6 is vacuum.

Besides, in a first embodiment of the present disclosure, a plurality of lenses 7 are arranged at one side of the separator 4 facing the assembling cavity 5 and each of them is assigned to one lighting assembly 9. In the present embodiment, the lenses 7 and the separator 4 are formed in one piece (see FIG. 2). FIG. 2 is an enlarged schematic diagram of region A in FIG. 1. As can be seen from FIG. 2, the printed circuit board 10 of the illuminating apparatus is provided with the lighting assemblies 9, and light from the lighting assembly 9 is emergent passing through the lens 7 and the separator 4. In the present embodiment, the transparent cover 3, the separator 4 and the lenses 7 are formed in one piece from plastic or glass, and of course, these parts also may be formed individually.

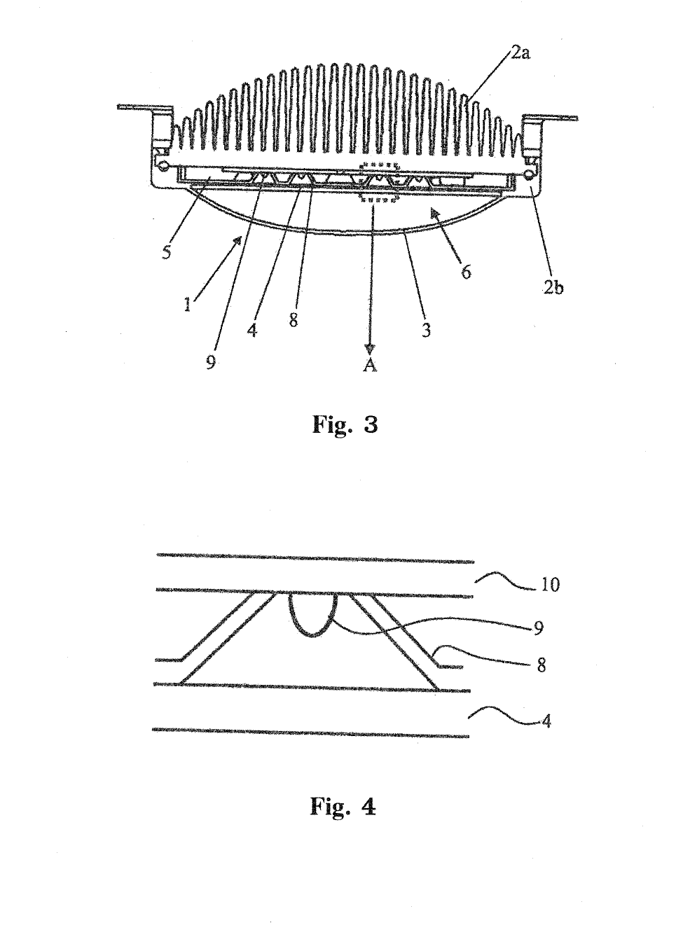

FIG. 3 is a sectional view of a second embodiment of the housing according to the present disclosure. The difference between the second embodiment and the first embodiment merely lies in that a plurality of reflectors 8 are arranged at one side of the separator 4 facing the assembling cavity 5 to replace the lenses 7 in the first embodiment, and each of the reflectors 8 is assigned to one lighting assembly 9. FIG. 4 is an enlarged schematic diagram of the region A in FIG. 3.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF REFERENCE SIGNS

1 housing

2a housing portion

2b housing portion

3 transparent cover

4 separator

5 assembling cavity

6 isolated cavity

7 lens

8 reflector

9 lighting assembly

10 printed circuit board

1. A housing for an illuminating apparatus, comprising:
two housing portions assembled together, and
a transparent cover,
the two housing portions and the transparent cover jointly defining a cavity,
wherein a transparent separator is provided in the cavity for separating the cavity into an assembling cavity and an isolated cavity sealed with respect to each other, wherein the assembling cavity is configured to mount a plurality of lighting assemblies of the illuminating apparatus, and the isolated cavity is defined jointly by the transparent cover and the separator.

2. The housing according to claim 1, wherein the isolated cavity is vacuum.

3. The housing according to claim 1, wherein a plurality of lenses are arranged at one side of the separator facing the assembling cavity and each of them is assigned to one lighting assembly.

4. The housing according to claim 3, wherein the lenses and the separator are formed in one piece.

5. The housing according to claim 1, wherein a plurality of reflectors are arranged at one side of the separator facing the assembling cavity and each of them is assigned to one lighting assembly.

6. The housing according to claim 1, wherein one of two housing portions which is not mounted with the transparent cover is configured as a heat sink.

7. The housing according to claim 1, wherein the separator is formed in one piece with one of the two housing portions which is provided with the transparent cover.

8. The housing according to claim 1, wherein the separator and the transparent cover are made from a glass or plastic.

9. An illuminating apparatus, wherein the illuminating apparatus has a housing, the housing comprising:
two housing portions assembled together, and
a transparent cover,
the two housing portions and the transparent cover jointly defining a cavity,
wherein a transparent separator is provided in the cavity for separating the cavity into an assembling cavity and an isolated cavity sealed with respect to each other, wherein the assembling cavity is configured to mount a plurality of lighting assemblies of the illuminating apparatus and the isolated cavity is defined jointly by the transparent cover and the separator.
